(19) United States
(12) Patent Application Publication
(10) Pub. No.: US 2002/0049780 A1
(43) Pub. Date: Apr. 25, 2002

(54) Serving hypermedia documents

(76) Inventor: Julian Goring Archdale Ellison, London (GB)

Correspondence Address: MCDERMOTT, WILL & EMERY, 600 13th Street, N.W., Washington, DC, 20005-3096, US

(21) Appl. No.: 09/789,705

(22) Filed: Feb. 22, 2001

(30) Foreign Application Priority Data
Feb. 25, 2000 (GB) 0004554.2

(51) Int. Cl. G06F 7/00

(52) U.S. Cl. 707/500.1

(57) ABSTRACT

The pages served to a user by a web server (12) are determined by or configured in dependence on a user id and a content id that have previously been established by a telephone call. A main page from the web server (12) request that the user enter the user id which is reported back to the server (12). The server (12) then retrieves the context id associated context id and serves (12) a page in dependence on the context id.

### FIELD OF THE INVENTION

The present invention relates to the serving of hypermedia documents.

### BACKGROUND TO THE INVENTION

People are familiar with telephones and the World Wide Web as means of communication. However, they are used independently.

### SUMMARY OF THE INVENTION

It is an aim of the present invention to provide for convergence between telephone and hypermedia communication.

The term “hypermedia document” means HTML documents and the like.

According to the present invention, there is provided a method of serving hypermedia documents, the method comprising:

generating a user id from a received telephone call and generating a context id in dependence on the circumstances of the telephone call;

storing the context id in association with the user id;

dispatching a first hypermedia document in response to a request therefor from a user, the first hypermedia document comprising means to receiving a user id and causing the user id to be sent in a request for a second hypermedia document;

receiving a request for the second hypermedia document;

determining the context id associated with the user id sent in said request;

configuring or selecting the second hypermedia document in dependence on the determined context id; and

sending the second hypermedia document to the requester.

According to the present invention, there is also provided an apparatus for serving hypermedia documents, the apparatus comprising:

telephony terminal equipment for receiving telephone calls;

a hypermedia server means; and

processing means for generating a user id from a telephone call received by the telephony terminal equipment, generating a context id in dependence on the circumstances of the telephone call and storing the context id in association with the user id,

wherein the hypermedia server means is configured for:

dispatching a first hypermedia document in response to a request therefor from a user, the first hypermedia document comprising means to receiving a user id and causing the user id to be sent in a request for a second hypermedia document;

receiving a request for the second hypermedia document;

determining the context id associated with the user id sent in said request;

configuring or selecting the second hypermedia document in dependence on the determined context id; and

sending the second hypermedia document to the requester.

The first and second hypertext documents need not be sent from the same location or web server process.

The circumstances may comprise the identity of a contemporaneous event. However, the circumstances may comprise an aspect of the content, e.g. a spoken word or a DTMF sequence, of the call or the time at which or date on which the call is made.

Preferably, the user id comprises the telephone number from which said call is made. More preferably, the telephone number is automatically determined. However, the user could be asked to enter a user-selected id using the telephone's keypad or speak in id. If the id is spoken, an applet may be associated with the first hypermedia document to enable the user to speak his id and have it send, e.g. as a compressed audio file, in the request for the second hypermedia document.

### BRIEF DESCRIPTION OF DRAWINGS

FIG. 1 schematically illustrates a state machine server employed in an embodiment of the present invention;

FIG. 2 shows an embodiment of the present invention; and

FIG. 3 shows a television image broadcast in the embodiment shown in FIG. 2.

### DESCRIPTION OF PREFERRED EMBODIMENT

An embodiment of the present invention will now be described, by way of example, with reference to the accompanying drawings.

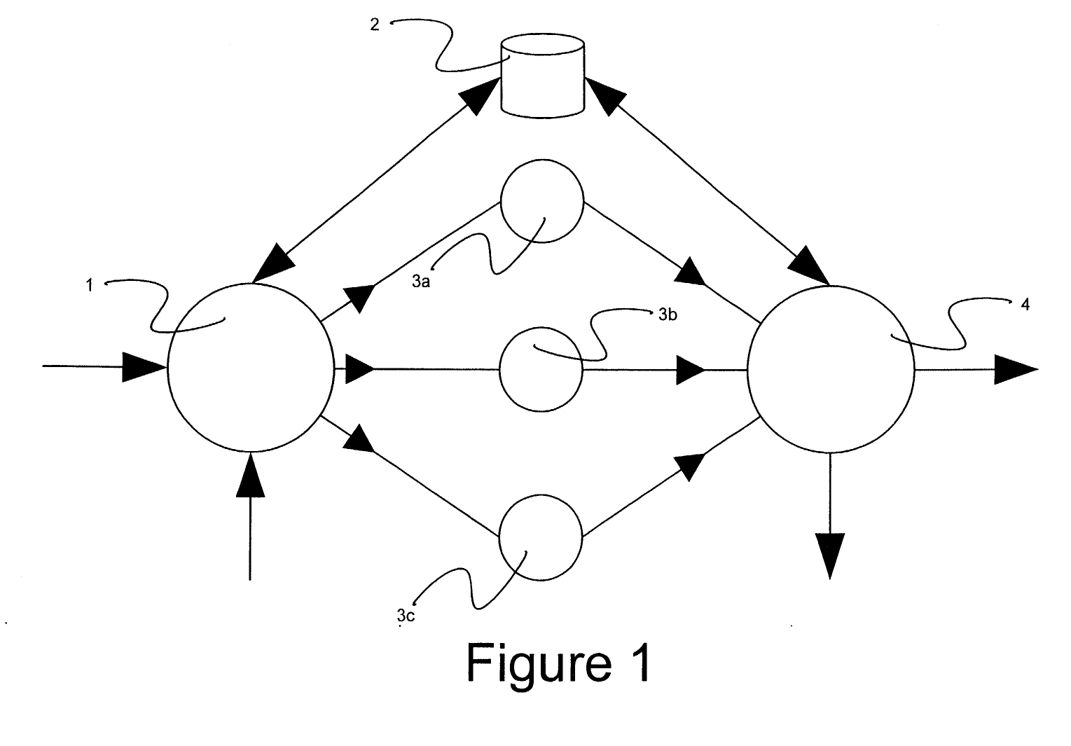

Referring to FIG. 1, a state machine server comprises an input router 1, a database 2, a plurality of state machines 3a, 3b, 3c and an output router 4. The input router 1 receives input data from a plurality of sources, e.g. mobile telephones, web browsers, in messages. These messages contain at least a session reference, e.g. indication of the source of the data or a session ID, and the data itself. The database 2 contains input and output routing tables. When the input router 1 receives a message, it queries the database 2 using the session reference in the message and obtains in response the identity of one of the state machines 3a, 3b, 3c. At least the data in the message is then routed to the identified state machine 3a, 3b, 3c by the input router 1. The state of the identified state machine 3a, 3b, 3c may change in response to the data in the message and an output may be generated, if such is required by the new state. Such outputs comprise output control messages which include at least an output device ID and an output device command. The outputs from the state machines 3a, 3b, 3c are handled by the output router 4 which routes them to the appropriate output device, e.g. a display unit or an audio unit for sending audio via a mobile telephone.

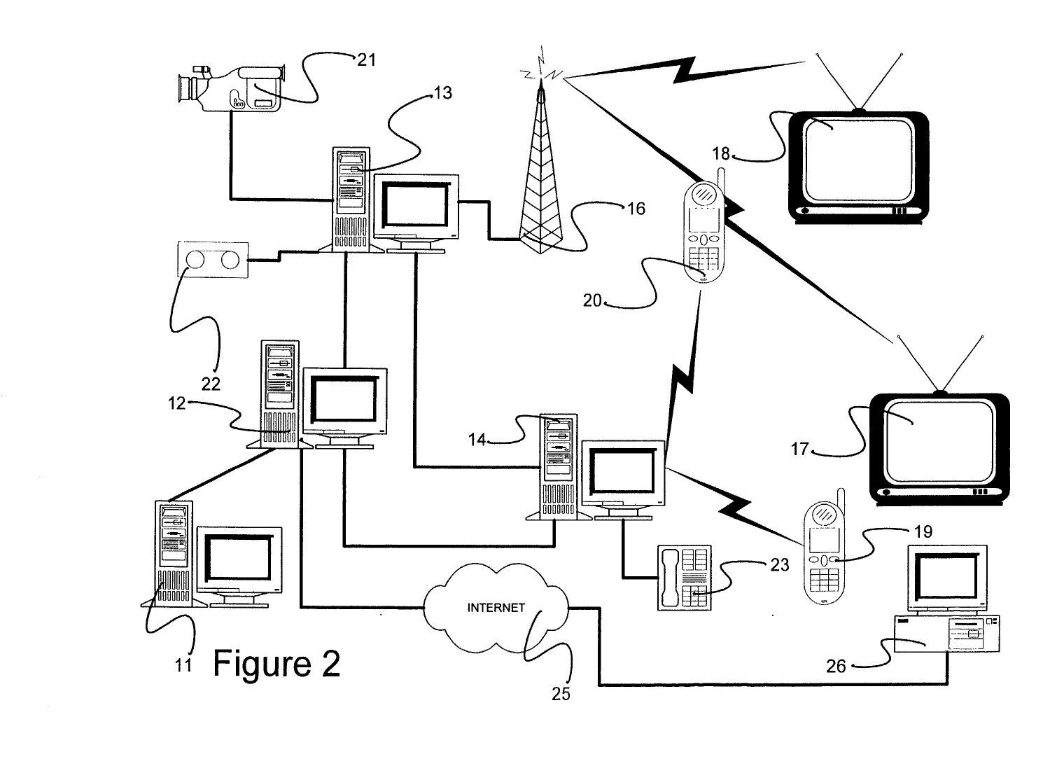

Referring to FIG. 2, an interactive television system comprises a master station 11, a server machine 12 connected to the master station 11, a television processor 13 and a communications processor 14. The server machine 12 hosts a state machine server as described above and a web server process. The television processor 13 and the communications processor 14 are connected to the server 12 for the exchange of messages therewith. An audio signal path is provided between the television processor 13 and the communications processor 14. The system also includes a television transmitter 16 for transmitting television signals generated by the television processor 13, first and second televisions 17, 18 for receiving the television signal transmitted by the transmitter 16, and first and second digital mobile telephones 9, 10 near the first and second televisions 17, 18 respectively.

The television processor 13 is connected to receive signals from a video camera 21 and a video tape 22. The television processor 13 can also generated graphical and text images under program control.

The communications processor 14 can engage in a plurality of telephone calls, e.g. with the mobile telephones 19, 20, simultaneously and is connected to bank of telephony terminals 23.

The server 12 is generally responsive to signals from the communications processor 14 to send command signals to the television processor 13 and back to the communications processor 14.

The server 12 supports a web server process which is accessible via the Internet 25 to a web browser running on a personal computer 26, located near the first television 17.

The master station 11 is used to control the server 12, e.g. initialising the state machine server and the web server process its operation, and for sending control files, defining the server's operation and the web pages that can be served, to the server 12.

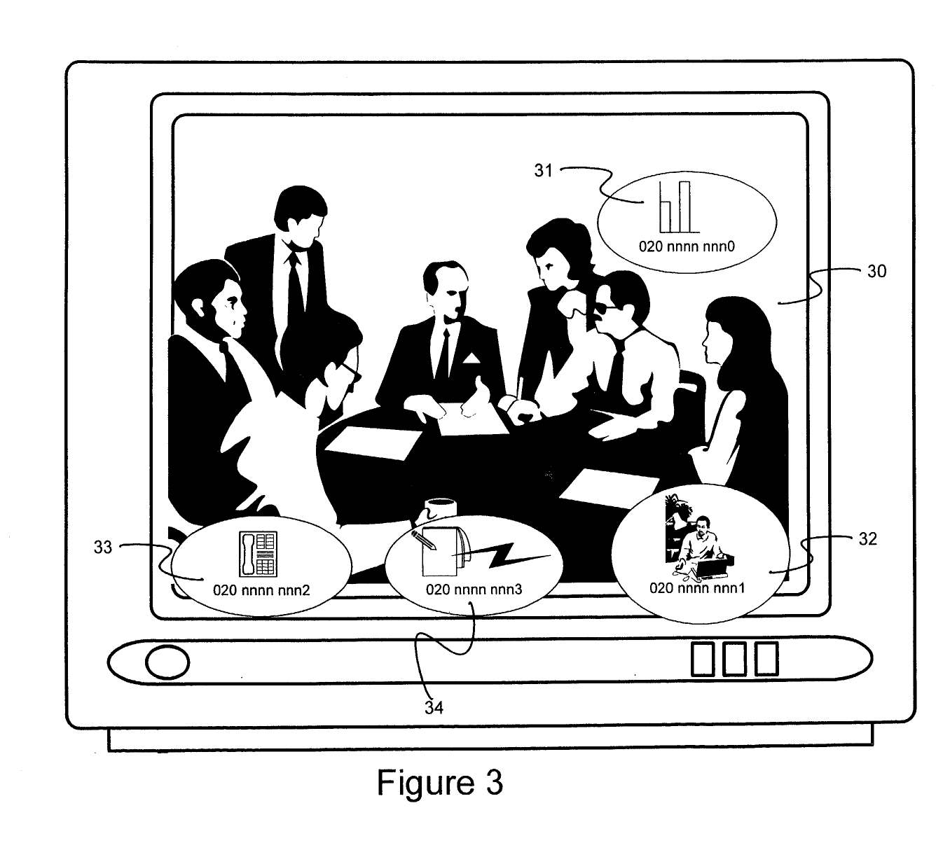

Referring to FIG. 3, a television picture produced by the television processor 13 is for a discussion program and comprises a main image 30 showing a discussion group, obtained from the tape 22, and first, second, third and fourth overlays 31, 32, 33, 34. The first overlay 31 includes a graph illustrating yes and no votes made by the public in response to the discussion and a first telephone number. The second overlay 32 contains a video image of an expert, filmed using the video camera 31, giving a commentary on the discussion taking place in the main image and a second telephone number. The third overlay 33 contains the image of a telephone and a third telephone number. The image of a telephone is an invitation to viewers to call a “helpline” related to the subject of the discussion. The fourth overlay 24 contains an image of a notepad and a communication “flash” and a fourth telephone number. The image in the fourth overlay 34 is an invitation to viewers to request additional information.

When the television programme shown in FIG. 3 is to be transmitted, an operator sends a initialisation signal to the state machine server at the server 12 from the master station 11. The state machine server at the server 12 responds by instantiating state machine control object instances associated with each of the overlays 31, 32, 33, 34.

The operation of the present embodiment in respect of the first overlay 31 will now be described.

When a viewer dials the first number using his telephone 19, 20, the call is answered by the communications processor 14. The communications processor 14 then generates a message comprising a voting “function ID” in a routing part and “new call=[channel no.]” in a data part. The channel number identifies a logical channel that the communications processor 14 can use to send signals to the new caller. The message is then sent to the server 12.

The message is received by a routing process at the server 12 which obtains the ID of the control object instance for the first overlay 31 from an input routing table, set up using the master station 12, using the routing part of the message. The routing process then invokes a message handling method of the appropriate control object instance. The method responds to the message by generating a “play invitation” message comprising the function ID and “comms” in the routing part and “[channel no.]=play invitation” in the data part. This message is returned to the routing process which sends it to the communications processor 14 after looking up the destination in an output routing table, set up using the master station, using the routing part of the message.

When the communications processor 14 receives the message it responds by playing an audio file, telling the caller to press “1” for yes and “0” for no, via the logical channel specified in the message. The communications processor 14 then waits for a digit to be input. When a “1” or a “0” has been entered by the caller, the communications processor 14 hangs up and generates a “vote” message comprising the function ID in the routing part and “vote=[yes/no]” in the data part.

The “vote” message is routed to the appropriate control object instance which responds by updating a local record of yes or no votes as necessary and incrementing a count of votes. If the count of votes equals a predetermined number, the percentage of yes votes is calculated and the count reset to zero. A message, comprising the function ID and “video” in the routing part and “percentage=[percentage]” in the data part, is then returned to the routing process and sent to the television processor 13. If the count has not reached the predetermined number, an empty message is returned to the routing process which ignores it.

When the television processor 13 receives the “percentage message”, it redraws the graph in the first overlay 31 to illustrate the new ratio of yes and no votes.

The operation of the present embodiment in respect of the second overlay 32 will now be described.

When a viewer dials the second number using his telephone 19, 20, the call is answered by the communications processor 14. The communications processor 4 then generates a message comprising an audio feed “function ID” in a routing part and “new call=[channel no.]” in a data part. The channel number identifies a logical channel that the communications processor 14 can use to send signals to the new caller. The message is then sent to the server 12.

The message is received by a routing process at the server 12 which obtains the ID of the control object instance for the second overlay 32 from the input routing table. The routing process then invokes a message handling method of the appropriate control object instance. The method responds to the message by generating a “feed audio” message comprising the function ID and “comms” in the routing part and “[channel no.]=feed audio” in the data part. This message is returned to the routing process which sends it to the communications processor 4 after looking up the destination in the output routing table.

When the communications processor 14 receives the message it responds by connecting the audio feed from the television processor 13 to the logical channel specified in the message. Consequently, the viewer can hear the expert via his telephone 19, 20.

When the viewer hangs up, the communications processor 14 generates a message comprising an audio feed “function ID” in a routing part and “[channel no.]=hung up” in a data part. The message is then sent to the server 12.

The message is received by a routing process at the server 12 which obtains the ID of the control object instance for the second overlay 32 from an input routing table. The routing process then invokes the message handling method of the appropriate control object instance. The method responds to the message by generating an “on hook” message comprising the function ID and “comms” in the routing part and “[channel no.]=on hook” in the data part. This message is returned to the routing process which sends it to the communications processor 14 after looking up the destination in the output routing table.

The communications processor 14 responds by breaking the link between the audio feed from the television processor 13 and the specified logical channel and drops the telephone line associated with the specified channel number.

The operation of the present embodiment in respect of the third overlay 33 will now be described.

When a viewer dials the third number using his telephone 19, 20, the call is answered by the communications processor 14. The communications processor 4 then generates a message comprising an phone “function ID” in a routing part and “new call=[channel no.]” in a data part. The channel number identifies a logical channel that the communications processor 14 can use to send signals to the new caller. The message is then sent to the server 12.

The message is received by a routing process at the server 12 which obtains the ID of the control object instance for the third overlay 33 from the input routing table. The routing process then invokes a message handling method of the appropriate control object instance. The method responds to the message by selecting the ID of a free telephony terminal 33 from a list thereof, setting a busy flag associated with it to true, and generating a “connect” message comprising the function ID and “comms” in the routing part and “[channel no.]=[terminal ID]” in the data part. This message is returned to the routing process which sends it to the communications processor 14 after looking up the destination in the output routing table.

When the communications processor 14 receives the message it responds by connecting the specified telephony terminal 23 to the logical channel specified in the message. The viewer can then talk to the operator of the specified telephony terminal.

If the viewer hangs up, the communications processor 14 generates a message comprising a phone “function ID” in a routing part and “[channel no.]=hung up” in a data part. The message is then sent to the server 12.

If the operator of the telephony terminal 23 terminates the call, the communications processor 14 generates a message comprising a phone “function ID” in a routing part and “[terminal no.]=terminated” in a data part. The message is then sent to the server 12.

When the “hung up” or “terminated” message is received by the routing process at the server 12, the routing process then invokes the message handling method of the appropriate control object instance. The method responds to the message by generating a “disconnect” message comprising the function ID and “comms” in the routing part and “[channel no.]=disconnect” in the data part. This message is returned to the routing process which sends it to the communications processor 4 after looking up the destination in the output routing table.

The communications processor 14 responds by breaking the link between the telephony terminal 23 and the specified logical channel and drops the telephone line associated with the specified channel number. The communications processor 14 then sends a “complete” message, comprising the function ID in the routing part and “[channel no.]=complete” to the server 12. At the server 12, the message is routed to the appropriate control object instance which responds by setting the busy flag for the telephony terminal to false and returning an empty message.

The operation of the present embodiment in respect of the fourth overlay 34 will now be described.

When a viewer, who has access to a personal computer 26, dials the fourth number using his telephone 19, the call is answered by the communications processor 14 which stores the caller's telephone number. The communications processor 14 then generates a message comprising an information “function ID” in a routing part and “new call=[channel no.]“in a data part. The channel number identifies a logical channel that the communications processor 14 can use to send signals to the new caller. The message is then sent to the server 12.

The message is received by a routing process at the server 12 which obtains the ID of the control object instance for the fourth overlay 34 from the input routing table. The routing process then invokes a message handling method of the appropriate control object instance. The method responds to the message by generating a “play options” message comprising the function ID and “comms” in the routing part and “[channel no.]=play options” in the data part. This message is returned to the routing process which sends it to the communications processor 14 after looking up the destination in an output routing table.

When the communications processor 14 receives the message it responds by playing an audio file, telling the caller that he can receive additional information by pressing ”1” for short message service, “2” for e-mail, “3” for fax and “4” for World Wide Web or cancel by pressing “0”, via the logical channel specified in the message. The communications processor 14 then waits for a digit to be input. When a “1”, “2”, “3”, “4” or “0” has been entered by the caller, the communications processor 14 generates a “mode” message comprising the function ID in the routing part and “mode=[entered digit]” in the data part

The “mode” message is routed to the appropriate control object instance at the server 12.

If the mode is “0”, the method returns an “on hook” message, comprising the function ID and “comms” in the routing part and “[channel no.]=on hook”, which is sent to the communications server 14. The communications server 14 responds in this case, by dropping the telephone call identified by the channel number.

If the mode is “1”, “2”, “3” or “4”, the method returns a “get number” message, comprising the function ID and “comms” in the routing part and “[channel no.]=get number” in the data part. This message is sent to the communications processor 14 which responds by generating a “telephone number” message, comprising the function ID in the routing part and “number =[telephone number]”. The telephone number for the viewer has been obtained using caller line identification (CLI). The “telephone number” message is sent to the server 12 where it is sent to the message handling method of the appropriate control object instance.

If the mode is not “4”, the method looks up the viewer's short message service, e-mail or fax address/number in a registered user database in dependence on the contents of the previously received mode message. If there is not an entry for the telephone number, the method returns an “unregistered” message, comprising the function ID and “comms” in the routing part and “[channel no.]=unregistered” in the data part, which is sent to the communications processor 14. The communications processor 14 responds to this message by playing an audio file through the specified channel and then dropping the line. The audio file gives the view instructions for registering, e.g. by telephone or e-mail or through a web page form.

If the mode is “1” and an short message service number is found, the method sends a message, comprising the function ID and “comms” in the data part and “[channel no.]=[short message service number] in the data part, to the communications server 14. The communications server 14 responds by playing an audio file through the specified channel to inform the user that the information is being sent by short message service and then drops the line. Then it sends the information, which was previously stored at the communication processor 14, in a series of short message service messages to the viewer's mobile telephone 19, 20.

If the mode is “2” and an e-mail address is found, the method sends a message, comprising the function ID and “master” in the data part and “send=[e-mail address, channel no.] in the data part, to the master station 11. The master station 11 responds by adding the e-mail address to a list of addresses to which the information is to be sent and then sends a “spooled” messaged, comprising the function ID in the routing part and “[channel no.]=spooled” in the data part, to the server 12. This message is routed in the normal way to the message handling method of the appropriate control object instance.

Similarly, if the mode is “3” and a fax number is found, the method sends a message, comprising the function ID and “master” in the data part and “send=[fax number, channel no.] in the data part, to the master station 11. The master station 11 responds by adding the fax number to a list of fax numbers to which the information is to be sent and then sends a “spooled” messaged, comprising the function ID in the routing part and “[channel no.]=spooled” in the data part, to the server 12. This message is routed in the normal way to the message handling method of the appropriate control object instance.

On receiving a “spooled” message, the method returns a “spool report” message, comprising the function ID and “comms” in the routing part and “[channel no.]=spooled” in the data part, which is then sent to the communications processor 14.

The communications server 14 responds by playing an audio file through the specified channel to inform the user that the information is being sent by the chosen method and then drops the line.

If it is determined that the mode is “4”, the method does not query the registered user database. Instead, it stores the telephone number and a programme id in a web server control database and then sends a message, comprising the function ID and “comms” in the data part and “[channel no.]=“web enabled” in the data part, to the communications server 14. The communications server 14 responds by playing an audio file through the specified channel to inform the user that the information is available to him at a particular web site.

When the viewer desires to obtain the additional information, he uses his personal computer 26 access the web site mentioned in the message which was sent in response to the “web enabled” message. The viewer submits the URL for the web site's home page and the web server running on the server 12 sends the HTML document for its home page. This document defines a frame into which is loaded an HTML form document. This document includes a text box, a submit button and an invitation to enter one's telephone number in the text box. The viewer enters his telephone number in the text box and clicks on the button. This causes the web browser to submit the form's action URL with the telephone number as a parameter.

The form's action URL is a reference to a CGI program on the server 12. When the web server at the server 12 receives the request including the action URL is runs the specified program.

The specified program queries the web server control database using the entered telephone number. Since the viewer called earlier during the television programme and selected mode “4”, the query returns the associated programme id. The CGI program then responds by “printing” a short HTML document that automatically replaces itself with the first page of a set of linked pages relating to the television programme whose id was obtained from the web server control database. The CGI program responds to different programme ids by including different replacing page URLs in the short HTML document.

The short HTML document is loaded by the web browser at the personal computer 26 into the frame and is quickly replaced by the first programme specific page.

When the television program finishes, an operator at the master station 11 causes the master station to send a shut down command to the server 12 which completes any outstanding transactions and terminates its processing of messages from the communications processor 14. However, the web server process continues to run. The server 12, the television processor 13 and the communications processor 14 can then be reconfigured for another television programme.

In another embodiment, the CGI program “prints” the first page of the program-specific set directly rather than causing it to be displayed indirectly by means of the short HTML document.

In a further embodiment, the CGI program also “prints” the first page of the program-specific set directly rather than causing it to be displayed indirectly by means of the short HTML document. However, this pages is produced by inserting the information relating to the television programme into a predetermined location in a template HTML document.

In the above-described embodiments, the CGI programs are used to determine the content to be sent to the viewer. It will be appreciated, however, that other technologies such a PHP Hypertext Pre-processing and Active Server Pages could be used.

1. A method of serving hypermedia documents, the method comprising:
generating a user id from a received telephone call and generating a context id in dependence on the circumstances of the telephone call;
storing the context id in association with the user id;
dispatching a first hypermedia document in response to a request therefor from a user, the first hypermedia document comprising means to receiving a user id and causing the user id to be sent in a request for a second hypermedia document;
receiving a request for the second hypermedia document;
determining the context id associated with the user id sent in said request;
configuring or selecting the second hypermedia document in dependence on the determined context id; and
sending the second hypermedia document to the requester.

2. A method according to claim 1, wherein said circumstances comprises the identity of a contemporaneous event.

3. A method according to claim 1, wherein the user id comprises the telephone number from which said call is made.

4. A method according to claim 3, wherein the telephone number is automatically determined.

5. An apparatus for serving hypermedia documents, the apparatus comprising:
telephony terminal equipment for receiving telephone calls;
a hypermedia server means; and
processing means for generating a user id from a telephone call received by the telephony terminal equipment, generating a context id in dependence on the circumstances of the telephone call and storing the context id in association with the user id,
wherein the hypermedia server means is configured for:
dispatching a first hypermedia document in response to a request therefor from a user, the first hypermedia document comprising means to receiving a user id and causing the user id to be sent in a request for a second hypermedia document;
receiving a request for the second hypermedia document;
determining the context id associated with the user id sent in said request;
configuring or selecting the second hypermedia document in dependence on the determined context id; and
sending the second hypermedia document to the requester.

6. An apparatus according to claim 5, wherein said circumstances comprises the identity of a contemporaneous event.

7. An apparatus according to claim 5, wherein the user id comprises the telephone number from which said call is made.

8. An apparatus according to claim 7, wherein the processing means is configured for determining the telephone number.
